(19) United States
(12) Patent Application Publication
(10) Pub. No.: US 2021/0162804 A1
(43) Pub. Date: Jun. 3, 2021

(54) MULTI-PART VEHICLE WHEEL WITH A SEAL

(71) Applicant: THYSSENKRUPP CARBON COMPONENTS GMBH, Wilsdruff STT Kesselsdorf (DE)

(72) Inventors: Jens WERNER, Coswig (DE); Florian FRANKE, Dresden (DE); Christian KÖHLER, Dresden (DE); Sandro MÄKE, Dohma (DE); Michael DRESSLER, Dresden (DE); Michael FRANKE, Dresden (DE)

(73) Assignee: THYSSENKRUPP CARBON COMPONENTS GMBH, Wilsdruff STT Kesselsdorf (DE)

(21) Appl. No.: 17/045,065

(22) PCT Filed: Apr. 18, 2019
(86) PCT No.: PCT/DE2019/100370

§ 371 Date: Oct. 2, 2020

(30) Foreign Application Priority Data
Apr. 20, 2018 (DE) 10 2018 109 562.7

(51) Int. Cl. B60B 23/08; B60B 3/04; B60B 3/10

(52) U.S. Cl. CPC B60B 23/08; B60B 2900/511; B60B 3/10; B60B 3/041

(57) ABSTRACT

A vehicle wheel includes a wheel disk, a wheel rim, and at least one connection element that connects the wheel disk to the wheel rim. The connection element is guided through a passage in the wheel rim and is joined in the wheel disk. A seal is provided to hermetically seal the passage of the wheel rim. One or more such seal is arranged between a connection region of the wheel disk and a connection region of the wheel rim, wherein the seal surrounds the connection element in a contact-free manner.

The invention relates to a vehicle wheel which comprises a wheel disk, a wheel rim and at least one connection element which connects the wheel disk and the wheel rim, wherein the connection element is guided through a passage in the wheel rim and is joined in the wheel disk. The wheel rim is intended for tubeless tires. In order to hermetically seal the passage of the wheel rim with respect to a tire chamber, a seal is provided.

The tire chamber refers to the space which is enclosed by the wheel rim and the mounted tire and which has to be sealed with respect to the environment.

The wheel disk may have a bowl shape, a disk shape or a star shape.

The wheel disk and the wheel rim are connected to each other in a positive-locking and/or non-positive-locking manner by means of the connection element.

If a plurality of connection elements are provided to connect the wheel rim and wheel disk, these may be guided through passages which are arranged, for example, along the periphery of the wheel rim and which engage in each case in one of the joining channels which are arranged correspondingly in the wheel disk.

Rivets, screws or stud bolts may be used as connection elements. In the connection, for example, by means of a screw, the screw head generally lies against the circumferential edge at the rim outer side of the passage of the wheel rim, wherein an outer thread of the screw engages in an inner thread of a joining channel of the wheel disk.

With such wheels, the difficulty involves sealing these passages through the wheel rim which are provided with a non-positive-locking connection in order to secure the wheel disk to the wheel rim in such a manner that no air can escape from the wheel chamber to the environment.

Document EP 1 858 715 B1 discloses a vehicle wheel which comprises a rim and a wheel bowl or a spoke unit, wherein connection elements are guided through the rim and are received in the wheel bowl or spoke unit. The sealing of the passage for the connection elements is carried out in such a manner that the connection elements have a seal.

This seal is arranged between the connection element and the rim outer side of the wheel rim or in the passage of the wheel rim and is consequently incorporated into the force transmission of the non-positive-locking connection, which involves the risk of damage to the seal during permanent operation of the motor vehicle wheel.

Another risk of damage to the seal arises from the relative movement of the connection element during the joining operation.

EP 1 619 043 A2 and U.S. Pat. No. 6,019,149 disclose spoke wheels in which the seal of the nipple spoke passage through the rib is carried out by means of sealing elements which are arranged above the connection element at the outer side of the rim. These seals each require structural space for the seal above the connection element.

It is particularly disadvantageous in the solution according to U.S. Pat. No. 6,019,149 that the mounting and removal of the tire may be made more difficult and the seal in this instance may become damaged.

In the embodiment according to EP 1 619 043 A2, the protruding structural space is reduced by the fact that the connection element is embedded in the wheel rim which, however, locally tapers the cross-section of the wheel rim and consequently reduces the durability of the wheel rim in a dangerous manner.

An object of the invention is to provide a vehicle wheel which overcomes the disadvantages of vehicle wheels according to the prior art which has been set out.

The invention is intended, for a vehicle wheel which comprises a connection of the wheel disk and wheel rim of the above type, to provide a dependable, operationally reliable and cost-effective sealing of the passage through the wheel rim. In this instance, using the seal, the strength and reliability of the connection between the wheel rim and wheel disk should not be impaired and damage to the seal during assembly and during vehicle operation should also be prevented. Furthermore, the mounting and removal of the tires should not be impeded by the configuration of the seal and damage to the seal should also be prevented in this instance.

The object is achieved by a vehicle wheel according to claim 1.

The following embodiments are in principle included by the invention:

Vehicle wheel which comprises a wheel disk, a wheel rim and at least one connection element which connects the wheel disk to the wheel rim, wherein the connection element is guided through a passage in the wheel rim and is joined in the wheel disk and a seal is provided to hermetically seal the passage of the wheel rim, wherein the seal (10) is arranged between a connection region of the wheel disk (2) and a connection region of the wheel rim (1), wherein the seal (10) surrounds the connection element(s) (4) in a contact-free manner.

Vehicle wheel according to 1, wherein a plurality of seals are arranged between a connection region of the wheel disk (2) and a connection region of the wheel rim (1), wherein the seals (10) surround the connection element(s) (4) in a contact-free manner.

Vehicle wheel according to 1 or 2, wherein a connection element (4) is in each case part of a multi-part connection arrangement (12), wherein the seal(s) (10) surround(s) the connection element(s) (4) in such a manner that there is no contact between the seal(s) (10) and the connection arrangement(s) (12).

Vehicle wheel according to 3, wherein the connection arrangement (12) comprises one or more bush portions (13, 13.1, 13.2).

Vehicle wheel according to 3 or 4, wherein the connection arrangement (12) comprises one or more perforated disk(s) (17) and/or one or more perforated plate(s).

Vehicle wheel according to 1 to 5, wherein the seal(s) (10) is/are arranged so as to extend coaxially around one or more connection element(s) or around one or more connection arrangement(s) (12).

Vehicle wheel according to 1 to 6, wherein at least two seals (10′, 10″) are arranged so as to extend radially around the periphery of the wheel disk or the wheel rim (1).

Vehicle wheel according to 1 to 7, wherein in a contact face (7) of the connection region of the wheel disk (2) and/or in a contact face (8) of the connection region of the wheel rim (1) there is/are formed one or more groove(s) (9) in which the seal(s) is/are arranged.

Vehicle wheel according to 1 to 8, wherein in an edge zone of the contact face (7) of the connection region of the wheel disk (2) and/or in an edge zone of the contact face (8) of the connection region of the wheel rim (1) there is formed a recess (16) in which the seal(s) (10) is/are arranged.

10. Vehicle wheel according to 1 to 9, wherein the seal (10) is constructed as a sealing element, preferably as an annular, perforated-disk-like or strip-like sealing element.

11. Vehicle wheel according to 1 to 9, wherein the seal comprises a sealing mass.

Vehicle wheel according to 1 to 11, wherein the seal comprises a resilient material, in particular fluoro rubber or silicone.

In the vehicle wheel according to the invention, the seal is arranged between a connection region of the wheel disk and a connection region of the wheel rim, wherein one or more connection element(s) is/are surrounded by the seal in such a manner that there is no contact between the seal and the connection element(s).

The connection region of the wheel disk comprises one or more connection faces which surround(s) the joining channel or the joining channels in the wheel disk and which can serve to connect the wheel disk to the wheel rim, whilst the connection region of the wheel rim comprises one or more connection face(s), which surround(s) the passage or passages of the wheel rim and which can be used for the connection of the wheel rim to the wheel disk.

Preferably, the outer, radial periphery of the wheel disk has one or more such connection faces, whilst a radial periphery of the rim inner side of the wheel rim has matching communicating connection faces for connecting the respective wheel disk to the wheel rim.

The connection region of the wheel disk may, for example, be formed on a radially extending wheel outer face (wheel flange) or on a plurality of individual end faces of the wheel spokes.

The connection face(s) of the wheel disk may be directed radially outward to axially laterally outward, wherein the connection face(s) of the wheel rim may be directed accordingly radially inward or axially sideward.

The connection face(s) of the wheel disk and the connection face(s) of the wheel rim are substantially facing each other in the assembled state of the vehicle wheel.

According to the invention the seal is arranged neither on the rim outer side nor in the passage of the wheel rim but instead exclusively between the connection region of the wheel rim and the connection region of the wheel disk, in particular between the contact faces thereof, in such a manner that they do not come into contact—either directly or indirectly—with the connection element.

Preferably, a plurality of seals are arranged between at least the connection region of the wheel disk and the connection region of the wheel rim.

Preferably, the seal(s) is/are arranged between at least one connection face of the connection region of the wheel disk and at least one connection face of the connection region of the wheel rim.

The seal(s) may be constructed in such a manner that it/they is/are arranged in the assembled state of the vehicle wheel in a locally differentiated manner, for example, as a sealing ring, in a specific portion between the connection faces of the wheel disk and the wheel rim or it/they extend(s) over the entire surface, for example, as a sealing film or a sealing disk, between these connection faces. Accordingly, the seal(s) may be locally delimited or lie against the connection faces of the wheel disk and the wheel rim over the entire surface.

In a contact region of the connection face(s) of the wheel disk and the connection face(s) of the wheel rim, there are formed in each case contact faces which in the assembled state of the vehicle wheel lie directly against each other or correspond indirectly by means of contact faces of intermediate elements of the connection arrangement.

In a first contact region of the connection face(s) of the wheel disk and the connection face(s) of the wheel rim, there are preferably formed in each case contact faces which in the assembled state of the vehicle wheel lie directly against each other or are indirectly in contact by means of contact face of intermediate elements of a connection arrangement. In this first contact region of the connection face(s), no intermediate seal is provided.

The seal(s) which is/are arranged between the connection face of the connection region of the wheel disk and the connection face of the connection region of the wheel rim are in this instance constructed and arranged in such a locally delimited manner that at least one connection face or a portion of a connection face of the wheel disk and at least one connection face or a portion of a connection face of the wheel rim is formed in each case as a first contact face for direct contact of the wheel disk with the wheel rim and/or for indirect contact of the wheel disk and/or the wheel rim by means of a connection arrangement. In the case of an indirect contact of the wheel disk and/or the wheel rim, the connection face of the wheel disk and/or the wheel rim lies against elements of the connection arrangement which support between the wheel rim and the wheel disk.

These first contact faces are consequently not in contact with a seal(s).

In a second contact region of the connection face(s) of the wheel disk and the connection face(s) of the wheel rim, there are formed contact faces (sealing faces) against which in the assembled state of the vehicle wheel the seal(s) lie(s) tightly.

For the seal(s) which is/are arranged between the connection faces or portions of the connection faces of the wheel disk and the wheel rim, at least one connection face or a portion of a connection face of the wheel disk and at least one connection face or a portion of a connection face of the wheel rim is formed in each case as a second contact face (sealing face) for direct contact of the seal(s) with the wheel disk and with the wheel rim.

In contrast to the first contact faces, these second contact faces are provided for direct, sealing abutment of the seal(s) against the wheel rim or the wheel disk.

The connection element used for the non-positive-locking connection of the wheel disk to the wheel rim may, for example, be a screw, a stud bolt or a rivet. In the wheel disk, corresponding joining channels for the engagement of the connection elements are provided. With a screw as a connection element, for example, an inner thread which corresponds to the outer thread of the screw is provided in the joining channel of the wheel disk.

The forces introduced by the connection elements bring about a surface pressure between the contact faces of the connection region of the wheel rim and the connection region of the wheel disk, in particular between the first contact faces of the connection region of the wheel rim and the wheel disk and consequently produce a non-positive-locking connection of the wheel disk and wheel rim.

The seal is in particular arranged between the connection faces of the wheel rim and the wheel disk which are produced as second contact faces always in such a manner that they have no contact—either directly or indirectly—with a connection element which is arranged in the respective passage or joining channel.

According to an advantageous embodiment, the seal can be arranged in adaptation to the respective geometric requirements and in order to increase the sealing function multiple times between the connection region of the wheel disk and the connection region of the wheel rim, in particular between the contact faces thereof, wherein also in this instance each of the seals surrounds the connection element(s) in a contact-free manner.

One or more seal(s) may, for example, be arranged indirectly or directly, but always with spacing around one or more connection element(s) and consequently so as to extend around the respective passage(s) or joining channel(s).

A plurality of seals which extend radially around the periphery of the wheel rim or the periphery of the wheel disk may, for example, be arranged so as to indirectly or directly flank one or more connection element(s) together in a contact-free manner and consequently be arranged so as to flank together the respective passage(s) or joining channel(s) of the connection element(s).

As a result of the surface pressure on the contact faces and the seal(s) which is/are associated therewith, in particular as a result of the surface pressure on the first—seal-free—contact faces, an efficient sealing action is achieved between the connection regions of the wheel rim and the wheel disk for sealing the passage by the wheel rim and consequently a rim-side sealing of the wheel chamber with respect to the environment.

The seals which are positioned with contactless spacing from the connection elements are thereby located largely outside the force path between the wheel rim and wheel disk which is introduced primarily by the connection elements via the direct engagement and contact faces thereof into the elements which are intended to be connected (wheel disk, wheel rim).

On the one hand, the force transmission which the connection element has to carry out is thereby not influenced and reduced by the seal. The connection remains stable and undisturbed to the greatest possible extent by the properties of the seal which are variable in a temperature-dependent and load-dependent manner.

On the other hand, the seal which is arranged in the manner described above is largely exempt from the effects of the forces applied and transmitted by the connection elements, in particular the dynamic loads which are transmitted during operation of the vehicle wheel. The dynamic loads acting on the connection elements during travel operation lead therein, for example, to tensile and transverse force loads and can consequently lead to a vibration friction wear of the components which are involved in the connection and which in particular lie directly against the connection element.

As a result of the spaced-apart positioning of the seal with respect to the connection elements, the seals are not subjected to the direct risk of damage resulting from these connection loads so that the sealing function of the seals remains permanently ensured. In particular, the risk of damage to the seals as a result of the dynamic connection loads is considerably reduced.

In addition, as a result of the arrangement of the seal(s) according to the invention, no space which with a raised structure could impede the mounting or the removal of the tire is taken up at the rim outer side. The function of the seal itself, as a result of its arrangement according to the invention, also cannot be impaired by the mounting or removal of the tire.

Furthermore, the seals cannot be impaired by the joining of the connection elements during the wheel assembly.

The positioning according to the invention, in particular the construction and the arrangement of the seal(s), enables using simple means and little complexity a permanently operationally reliable sealing of the passage of the wheel rim and consequently of the tire chamber with respect to the environment and at the same time ensures a reliable connection between the wheel rim and the wheel disk.

In another advantageous embodiment, the seal(s) is/are arranged so as to be only locally delimited between the connection faces and thus constructed and positioned in such an adaptable manner that a first contact region of the connection faces or a portion of the connection faces of the wheel disk and the wheel rim is constructed with one or more first contact face(s), the surface pressure, as a result of the forces introduced into the connection partners by the connection elements in order to produce the non-positive-locking connection of the wheel disk and wheel rim, takes place primarily in these first contact faces.

The seal(s) is/are consequently arranged both with contactless spacing from the connection elements and outside mutually corresponding, force-transmitting contact faces of the wheel disk and wheel rim.

The seals are consequently exempt from the direct surface pressures which act on the first contact faces and are thereby substantially located outside the force path between the wheel rim and wheel disk, which is introduced by the connection elements via the direct engagement faces thereof and further primarily via the contact faces into the elements which are intended to be connected (wheel disk, wheel rim).

The force transmission for an effective, non-positive-locking connection of the wheel disk and wheel rim is thereby improved. The contact faces which are free from sealing faces provide an efficient surface pressure. The connection additionally remains stable and uninfluenced by the properties of the intermediate seal which are variable in a temperature-dependent and load-dependent manner.

Furthermore, as a result of their positioning remote from the force-transmitting contact faces, the seals are not subjected to the risk of damage from the surface pressure applied to the contact faces so that the sealing function of the seals is ensured in an even safer manner.

Consequently, in addition to an efficient force transmission, at the same time a particularly efficient sealing action is achieved between the connection regions of the wheel rim and the wheel disk.

According to an advantageous embodiment, a connection element can also be part of a connection arrangement for connecting the wheel disk and the wheel rim, wherein the seal(s) surround(s) the connection element(s) in such a manner that there is no contact between the seal(s) and the connection arrangement(s).

The connection arrangement comprises in addition to the connection element additional components of the connection, such as, for example, one or more bush portions, a perforated disk or perforated plate, a washer, an insert, or another insertion or intermediate element, which, for example, may line or surround the passage of the wheel rim and/or the joining channel of the wheel disk and/or may extend between the connection regions of the wheel rim and the wheel disk. These components of the connection arrangement in order to support the non-positive-locking connection between the wheel disk and the wheel rim are in direct or indirect active contact with the connection element.

In particular, components of the connection arrangement which are constructed to surround the passage and the edge regions of the wheel rim surrounding the passage primarily serve both to protect the passage of the wheel rim from mechanical loading as a result of the passing, force-transmitting connection element and the force distribution from the local surface pressure between the connection element and the wheel rim. These measures are significant particularly with a wheel rim of fiber-reinforced plastics material in order to reduce the material loading of the fiber composite material in the connection region.

In this embodiment according to the invention, the seal(s) which is/are supported between the connection regions of the wheel disk and the wheel rim surround(s) the connection element(s) and preferably also other components of the connection arrangement in such a manner that the seal(s) is/are arranged in a contact-free manner with respect to all components of the connection arrangement(s).

In this instance, the seal(s) may surround the connection element(s) directly or indirectly, preferably incorporating components or elements of the connection arrangement(s).

For example, an annular seal may surround a component of the connection arrangement, such as a bush portion which borders the passage of the wheel rim with a flange-like collar or a perforated disk which surrounds the passage and through which the connection element is guided in each case, with a corresponding contactless spacing. The seal may surround the outermost, furthest extended component of the connection arrangement in a radial extent of the connection arrangement, but also be interposed between the different components of the connection arrangement as long as there is no contact with the connection element and the remaining components of the connection arrangement.

It is also thereby ensured, on the one hand, that no air can escape into the environment from the tire chamber via the passages through the wheel rim and explicitly through the joints or contact faces which are produced between the connection element which is guided through and the remaining components of the connection arrangement. On the other hand, as a result of the spaced-apart, contactless positioning of the seals with respect to all components of the connection arrangement which are operationally connected to each other, the seal is removed from the effects of the forces which are applied and transmitted by the connection arrangement, in particular from the dynamic loads which are transmitted during operation of the vehicle wheel, and consequently protected from damage resulting from the connection loads so that the sealing function of the seals remains permanently ensured.

The invention includes the fact that, on the one hand, each connection element or connection arrangement including the associated active components may be surrounded separately/individually by a seal or at least one seal.

On the other hand, it is also included by the invention that a plurality of connection elements or a plurality of connection arrangements including the associated active components may be surrounded in a state grouped by a single seal or at least one seal.

The invention further also includes the fact that the connection elements or connection arrangements including the associated active components may be surrounded by at least two seals which extend radially around the periphery of the wheel rim or wheel disk.

Consequently, either each passage of the wheel rim is sealed separately with respect to the environment in an air-tight manner or a group of passages is sealed together with respect to the environment in an air-tight manner. In both cases, a reliable sealing of the tire chamber is achieved.

The invention advantageously also includes the fact that in particular a plurality of seals which are arranged so as to extend coaxially or radially may surround one or more connection element(s) or one or more connection arrangement(s). The sealing action of the seals can thereby be multiplied in steps and consequently the durability and reliability of the seal can be further increased.

According to an advantageous embodiment, the connection arrangement has a multi-portion bush. As a result of a connection arrangement with a multi-portion bush, the vibration friction wear between the connection element and the wheel rim, in particular in a wheel rim of fiber-reinforced plastics material, is permanently reduced, which in particular with a wheel rim of fiber-reinforced plastics material is advantageous.

The bush portions may terminate flush with the outer or inner surface of the wheel rim or protrude beyond them or may have a flange which extends over the outer or inner surface of the wheel rim or extend in a recess or a joining channel of the wheel disk.

With, for example, a bush portion which is constructed to extend in a flange-like manner over the connection region of the wheel rim, the flange may be arranged between the connection faces of the wheel disk and the wheel rim, in particular between the first contact faces thereof and may consequently provide corresponding contact faces for indirect connection of the wheel disk to the wheel rim and for indirect force transmission between the connection region of the wheel disk and the connection region of the wheel rim.

The seal of the passage of the wheel rim may in this instance be carried out by a seal, which completely surrounds the flange-like bush portion with spacing and which is constructed to be adapted to the height of the flange of the flange-like bush portion. The seal is in particular constructed to lie against the second contact faces (sealing faces) in the connection region of the wheel rim 30 and the wheel disk.

A seal comprising, for example, resilient material, preferably comprises with respect to the height of the flange of the outer bush portion, an excess dimension and is in the assembled state of the connection compressed in accordance with the excess dimension and forms corresponding sealing faces (second contact faces) on the connection face of the wheel disk and the connection face of the wheel rim.

In particular multi-portion bushes with mutually engaging bush portions are suitable for compensating for the micro-movements which occur in the connection as a result of the dynamic loads of the vehicle wheel and minimizing the resulting vibration friction wear on the wheel rim of fiber-composite material.

In this embodiment, the seals are removed from the dynamic loads which are transmitted to the connection during operation of the vehicle wheel as a result of the positive actions of the micro-movements which are compensated for by the mutually engaging bush portions in a particularly advantageous manner.

According to an advantageous development of the vehicle wheel, the connection arrangement comprises one or more perforated disk(s) and/or one or more perforated plate(s).

Also in this embodiment in combination with a connection element and/or in combination with a connection element and additional components of the connection arrangement, a connection which is also effective and secure as described above can also be achieved.

Preferably, the seal(s) is/are arranged so as to extend coaxially around one or more connection element(s) or around one or more connection arrangement(s). In this instance, the seal(s) run(s) around a central, common axis of the connection element or the connection arrangement. In the case of a plurality of connection elements or connection arrangements, the seal(s) run(s) around a central common axis of the group of connection elements or connection arrangements.

The coaxially extending seal may comprise according to the desired wheel configuration any angular, annular, oval or curved peripheral profiles which extend between the connection region of the wheel rim and the connection region of the wheel disk around a connection element or a connection arrangement or a group of connection elements or connection arrangements, wherein a seal with an annular peripheral profile is particularly simple to produce and handle.

This embodiment is preferably suitable for a star-like wheel disk with individual spokes, but does not exclude an application for the sealing of the passages of a disk-like and bowl-like wheel disk with a closed, continuous outer periphery.

The connection region of the wheel rim and the connection region of the spoke ends of the star-like wheel disk have in each case substantially planar or slightly curved connection faces which in the assembly state of the vehicle wheel mutually correspond and are contacted in each case in the contact region by at least one seal which extends in the coaxial vicinity of the connection element or the connection arrangement. In the contact region of the wheel rim and the wheel disk, consequently, at least a first contact face and a second contact face which extends coaxially with respect to the connection element or the connection arrangement (sealing face) is formed.

With an in particular coaxial arrangement of the seal, as a result of the tightening torque of the connection element over the wheel rim and the wheel disk and further over the sealing faces thereof on the seal, a very uniformly distributed and consequently high pressing force can be applied. Consequently, a particularly high reliability of the seal is achieved.

According to an advantageous development of the vehicle wheel, the seal(s) is/are arranged so as to extend radially in a peripheral direction of the wheel disk or the wheel rim.

Preferably, two peripheral seals are arranged in pairs and at both sides of the connection elements (4) or connection arrangements (12) which are arranged around the periphery of the wheel disk (2) or the wheel rim (1) so that the connection elements or connection arrangements are enclosed by the two radially peripheral seals.

This embodiment is preferably suitable for a disk-like and bowl-like wheel disk having a closed, continuous, outer periphery. For example, the connection region of the wheel rim and the connection region of the wheel disk comprises radially extending, cylindrical or conical or parabolic, mutually facing connection faces which in the assembled state of the vehicle wheel mutually correspond and which are contacted in the contact region at both sides by at least one radially peripheral seal, respectively. Preferably, at both sides of a first contact face of the connection face of the wheel rim or the wheel disk two flanking second contact faces (sealing faces) for the abutment of the seals are formed in this instance.

The peripheral profile of the radially peripheral seal according to the wheel configuration follows the outer peripheral profile in the connection region of the wheel disk or the peripheral profile in the connection region of the wheel rim.

Also as a result of this embodiment of the sealing arrangement, the tire chamber is completely and reliably sealed against the discharge of air into the environment.

This radially extending sealing arrangement enables an effective wheel sealing with a particularly low level of technical complexity.

All passages of the wheel rim may together and in the same manner be enclosed in an air-tight manner by the seals which extend at both sides of the connection elements or connection arrangements.

This radially extending sealing arrangement may be provided alternatively or additionally to the coaxially extending sealing arrangement.

According to an advantageous embodiment of the invention, the seal(s) is/are connected in a substance-to-substance manner to a second contact face (sealing face) of the connection region of the wheel disk and/or to a second contact face (sealing face) of the connection region of the wheel rim.

The substance-to-substance connection of the seal(s) may, for example, be carried out by means of various adhesives or by means of, preferably self-adhesive, tape.

However, the seal(s) themselves may also have adhesive properties, for example, as a sealing adhesive or as a self-adhesive sealing tape, so that these seals can directly produce a substance-to-substance connection to the second contact faces.

With this substance-to-substance connection of the seal(s), the desired position of the seal(s) spaced apart from the connection element or the connection arrangement can already be fixed before the assembly of the connection. This additional position fixing of the seal(s) in addition to facilitating the assembly leads to a higher level of safety when the sealing action is applied in the assembled state.

According to another advantageous embodiment of the invention, in a connection face, in particular in a contact face of the connection region of the wheel disk and/or in a connection face, in particular in a contact face of the connection region of the wheel rim, at least one groove in which the seal(s) is/are arranged is/are formed.

In this embodiment, in at least one of the connection faces which mutually correspond in the assembled state of the vehicle wheel, in particular in at least one of the contact faces of the connection regions of the wheel disk and the wheel rim, which contact faces lie against each other, one or more grooves are incorporated. In the assembled state of the connection, the faces of the incorporated groove are formed as second contact faces (sealing faces).

The groove ensures a secure fit of the seal at the provided location without any risk of a positional displacement during the loading of the connection during operation of the vehicle wheel.

One or more seals may be incorporated in a groove. Together with the corresponding contact faces of the connection regions of the wheel disk or the wheel rim, in particular together with a second contact face (sealing face) of the connection region of the wheel disk or the wheel rim, which contact face is opposite the groove, the groove-supported seal provides reliable sealing of the passage of the wheel rim in the assembled state of the vehicle wheel.

The preferably resilient seal preferably has—with respect to the groove depth—an excess dimension. Consequently, the seal in the assembled state of the connection of the groove and the opposing contact face in each case (second contact face) is compressed in a manner fixed in position to a defined shape and thickness.

The force which is introduced by the connection element into the connection applies a pressing force to the seal in the groove which ensures reliable sealing between the connection regions of the wheel rim and the wheel disk. In particular, it can thereby be ensured that the sealing effect is safeguarded under any dynamic loading of the connection.

Depending on the resilience and the excess dimension of the seal, the pressing force of the seal and consequently the sealing action can be varied.

The mutually corresponding contact faces (first contact faces) in the connection regions of the wheel rim and the wheel disk can in a manner which is not influenced by the seals to the greatest possible extent not only support but also efficiently apply the necessary force transmission between the wheel rim and the wheel disk since in particular the seals which are arranged in the grooves are not located directly in the force path of the connection and in particular are excluded from the force path of the connection.

As a result of the integrated arrangement of the seal in the groove and as a result of an appropriate selection of the material, a creeping of the seal and consequently settlement of the connection can further be prevented.

Both in the connection region of the wheel rim and in the connection region of the wheel disk, there may be arranged grooves which together with the integrated seal may be arranged in particular opposite or offset with respect to each other, and accordingly may be effective multiple times.

According to the above-described possible path of the seal(s), one or more groove(s) in the connection region of the wheel rim may be arranged around a passage of the wheel rim or around a plurality of passages of the wheel rim.

Accordingly, one or more groove(s) may be arranged in the connection region of the wheel disk around a joining channel in the wheel disk or around a plurality of joining channels of the wheel disk.

According to the above-described possible path of the seal(s) which extend(s) radially in a peripheral direction of the wheel disk or the wheel rim, the associated grooves may also be constructed so as to extend radially in the connection region of the closed wheel disk and/or to extend radially in the connection region of the wheel rim and can consequently extend at both sides adjacent to the joining channels which are arranged in a state distributed around the outer periphery of the wheel disk or to the passages which are arranged in a state distributed around the periphery of the wheel rim.

Accordingly, the seals which are arranged in the grooves enclose the connection elements or connection arrangements which are arranged in a state distributed over the periphery of the vehicle wheel at both sides of the connection regions of the wheel rim and the wheel disk.

The embodiment of the grooves along the outer periphery of the closed wheel disk or along the periphery of the rim inner side of the wheel rim is particularly simple to produce and its use is particularly easy to assemble.

According to an advantageous embodiment of the invention, in an edge zone of a connection face, in particular the contact face of the connection region of the wheel disk and/or in an edge zone of a connection face, in particular the contact face of the connection region of the wheel rim, there is formed a recess in which the seal(s) is/are arranged. In the assembled state of the connection, the faces of the recess formed are consequently constructed as second contact faces (sealing faces).

The recess provided also brings about a secure fit of the seal at the predetermined location without position displacement during loading of the connection during operation of the vehicle wheel.

For the positionally secure arrangement of the seal, on the one hand, in an edge zone of the connection region of the wheel rim facing the passage of the wheel rim, that is to say, on the peripheral edge of the passage which adjoins the passage, a recess which faces into the passage and which is in particular open relative to the passage may be formed.

In an inner edge zone of the connection region of the wheel disk facing the joining channel in the wheel disk, that is to say, on the peripheral edge of the joining channel of the wheel disk, a recess which faces in the direction of the joining channel and which is in particular open toward the joining channel may also be formed.

Or, in an outer edge zone of the connection region of the wheel disk, an edge-side, outwardly facing recess which is in particular open toward the environment may be formed in the radial periphery of the closed wheel disk or in the periphery of each of the wheel spokes.

These recesses may be provided alternatively or additionally to the groove construction.

Material weaknesses in the edge zones of the connection regions of the wheel disk or the wheel rim which may be produced, for example, by the construction of grooves close to the edge can thus be prevented.

Such material weaknesses could be produced particularly during the construction of the wheel disk in the form of a star in the connection region of the spoke ends. Narrow residual wall thicknesses in the edge region of the spoke ends are subjected as a result of the significant loading of the spokes, to the risk of breaking out. Such undesirable damage to the wheel star may be prevented as a precautionary measure by the component recesses which are arranged directly at the edge of the spokes.

Also as a result of a recess of the peripheral edge of the passage of the wheel rim in the connection region of the wheel rim, residual wall thicknesses which may be at risk of breaking can be prevented by a groove which is formed near the edge.

In addition, the edge-side recess can be produced with a corresponding milling tool using technically simpler methods than a groove.

According to other advantageous embodiments, the seal is formed as a sealing element, preferably as an annular, perforated-disk-like or strip-like sealing element.

The seal, in particular the sealing element, may, for example, have a round, oval, rectangular or square cross-section.

The correspondingly prefabricated seal or the correspondingly prefabricated sealing element enables the sealing of the wheel rim to be carried out with little assembly complexity.

Annular, perforated-disk-like or strip-like seals or sealing elements enable the connection element(s) or the connection arrangement(s) to be surrounded in an integral manner and consequently enable the wheel rim to be sealed with little production complexity, for example, in one operating step, and in a particularly reliable manner.

These seals can be handled in an easy-to-assemble manner and in particular can be placed very comfortably in correspondingly suitably constructed grooves or edge-side recesses.

It is possible to use as the seal, for example, conventional sealing rings with a round cross-section (O-rings), a rectangular or square cross-section, strip-like flat seals with a rectangular cross-section, film-like sealing strips or perforated disks (sealing disks) with a rectangular cross-section, which are available in a cost-effective manner as mass-produced products.

An alternative embodiment of the seal involves the use of a shapeless sealing mass. The shapeless sealing mass may be extruded or otherwise introduced directly before the wheel disk is joined to the wheel rim in the grooves formed, edge-side recesses or joints between the respective contact faces (for example, between the provided second contact faces (sealing faces)), whereby the sealing mass receives the corresponding spatial delimitation and fixing and in this instance completely and securely fills the hollow spaces.

The sealing mass, if the grooves, edge-side recesses or joints remain accessible, may also be applied after the joining of the connection, which may have assembly advantages determined according to the specific case.

The shapeless sealing mass may, for example, comprise a hardening synthetic resin, such as, for example, polyurethane, which hardens after introduction or application.

Preferably, the seal, whether as a sealing element or a sealing mass, comprises a resilient material, in particular fluoro rubber.

As a result of the resilience of the material of the seal, it can be compressed between the respective contact faces (for example, between the provided, second contact faces (sealing faces)) of the connection regions of the wheel disk and the wheel rim and in particular in the grooves or edge-side recesses under the pressing force of the connection in a form-fitting manner, which ensures a reliable sealing of the wheel rim.

The use of fluoro rubber further ensures, as a result of its high degree of temperature resistance, a high structural stability of the seal for sealing the wheel rim even in the event of high thermal loads of the vehicle wheel.

Preferably, the seal, whether as a sealing element or sealing mass, comprises silicone. This material, in addition to its high level of resilience, is also very temperature-resistant with the above-mentioned aspects of safety for the sealing of the wheel rim.

It has been found to be particularly advantageous for a second contact face (sealing face) which is formed on the connection face of the wheel disk and/or a second contact face (sealing face) which is formed on the connection face of the wheel rim to have a fluid-tight coating. This coating is consequently formed between the seal and the sealing face(s).

In addition to the seal provided, this coating with a higher action may prevent moisture from the outer side from penetrating in an undesirable manner into the connection or connection arrangement between the wheel rim and wheel disk by fluid infiltrating the seal adjacent to the sealing face(s) and/or diffusing into the boundary regions between the seal and sealing face(s).

Particularly in wheel rims or the connection regions thereof which comprise fiber-composite material, and/or in wheel disks or the connection regions thereof which comprise fiber-composite material, moisture can also diffuse into the fiber-composite material so that in combination with metal components of the connection arrangement or metal wheel disks or wheel rims, occurrences of corrosion may appear when moisture becomes involved.

As a result of the coating provided, such occurrences of corrosion can be prevented so that permanent strength of the connection between the wheel rim and wheel disk can thereby be ensured.

The fluid-tight coating may, for example, be a layer of paint, as also used in the coating of fiber-composite components, such as, for example, in wheel rims or wheel disks of fiber-composite material, for moisture and/or UV protection.

Preferably, a connection face which adjoins the sealing face(s) and which is outwardly directed in the connection region of the wheel disk or the wheel rim and/or a surface of the wheel disk or the wheel rim which adjoins the sealing face(s) and which is outwardly directed is coated in a fluid-tight manner in order to extensively prevent penetration of moisture from the outer side and to increase the protective effect.

Preferably, a coating which is provided to protect the surface of the wheel disk or the wheel rim is constructed to extend extensively over the sealing face(s).

The embodiment according to the invention includes the fact that the first contact faces which are involved in the force transmission in the connection region of the wheel disk and the wheel rim are excluded from the coating so that there is no coating material in the force path of the connection, whereby a corrosion protection which protects the connection materials is achieved without impairing the force transmission in the connection.

Other advantageous embodiments and developments of the invention will be appreciated from the drawings and the associated descriptions of the embodiments.

The invention is explained in greater detail with reference to the following embodiments illustrated in the Figures.

In the drawings:

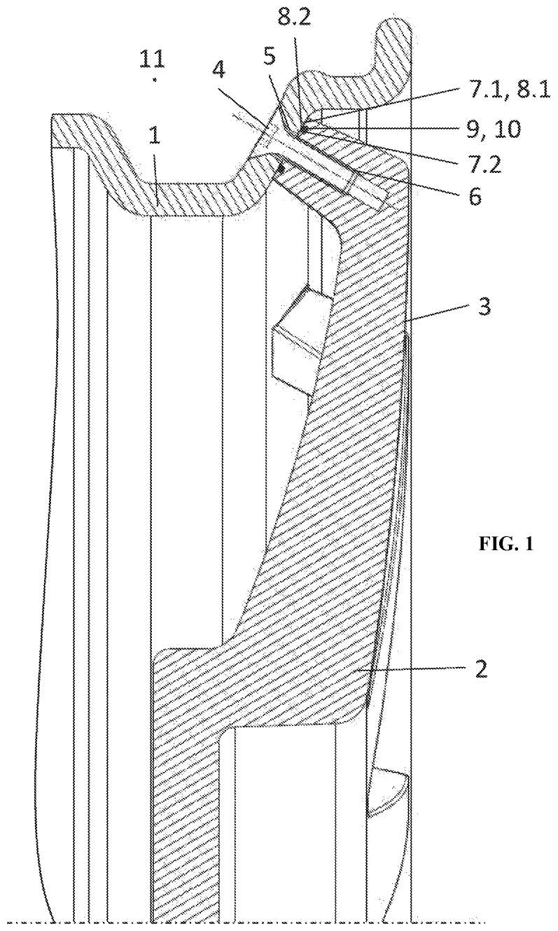

FIG. 1 is a sectioned illustration of a one-sided cut-out of a vehicle wheel with a star-shaped wheel disk which is connected to the wheel rim by means of connection elements with in each case a seal in an annular groove in the contact face (connection face) of the connection region of the spoke of the wheel disk,

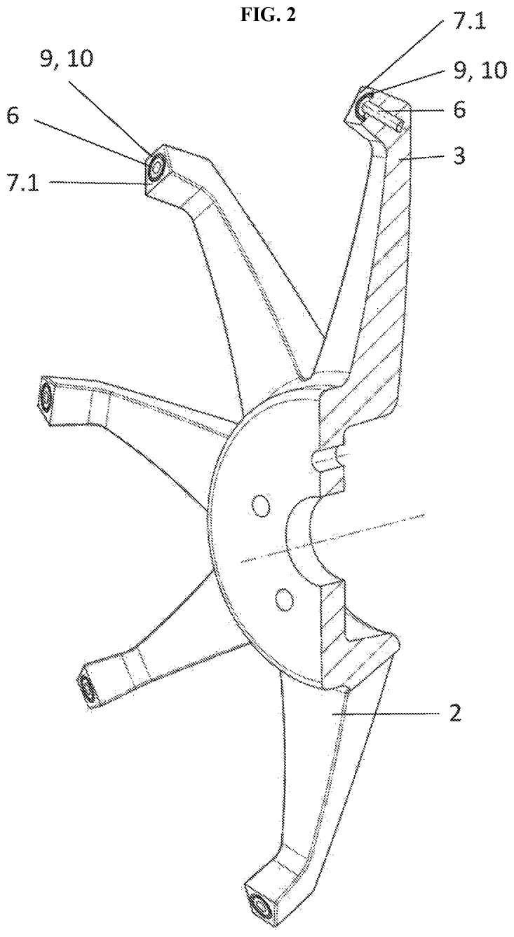

FIG. 2 is an isometric sectioned illustration of the star-shaped wheel disk according to FIG. 1,

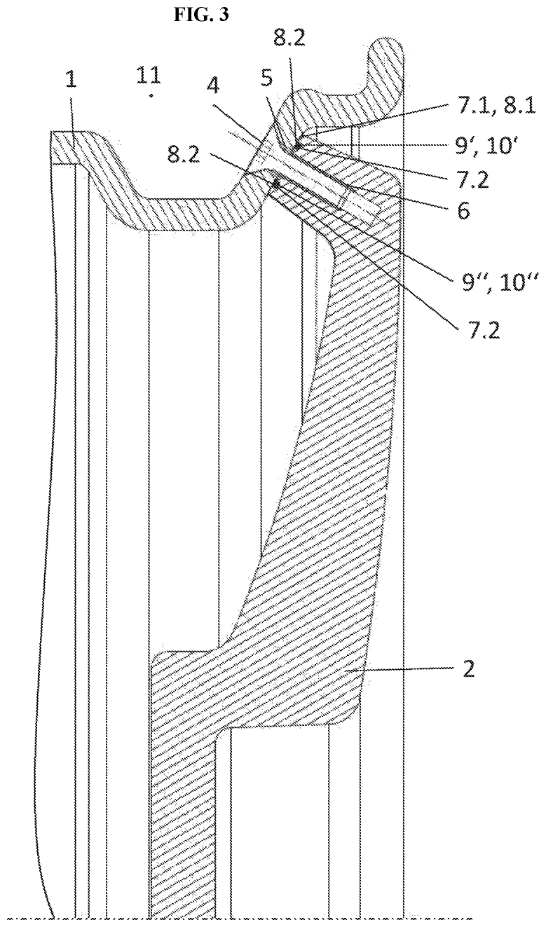

FIG. 3 is a sectioned illustration of a one-sided cut-out of a vehicle wheel with a bowl-like wheel disk which is connected to the wheel rim by means of connection elements, having two seals in a groove which extends radially around the periphery of the connection region of the wheel flange of the wheel disk in the contact face (connection face) of the wheel flange,

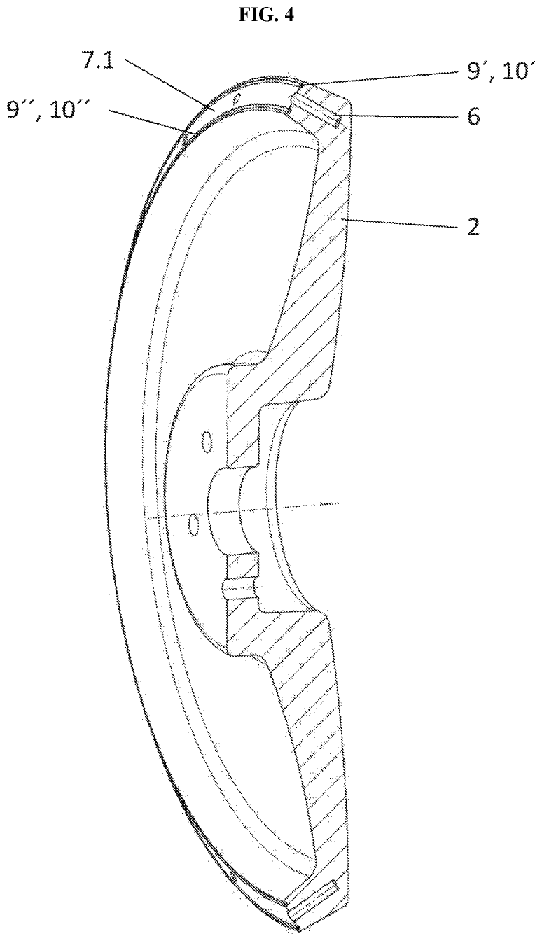

FIG. 4 is an isometric sectioned illustration of the bowl-like wheel disk according to FIG. 3,

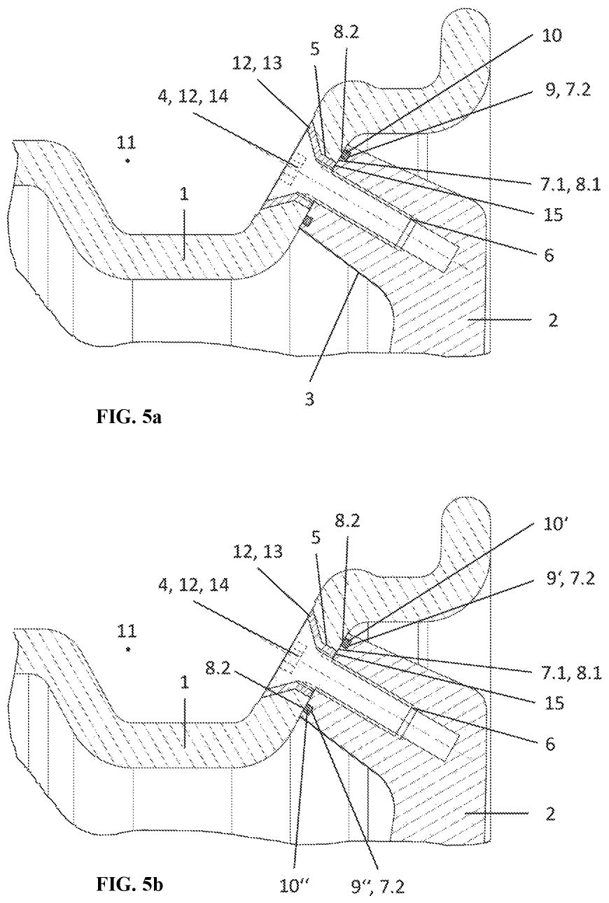

FIG. 5a is a sectioned illustration of a cut-out of a vehicle wheel having a star-like wheel disk which is connected to the wheel rim by means of connection arrangements, in each case having a seal in an annular groove in the contact face (connection face) of the connection region of the spoke of the wheel disk,

FIG. 5b is a sectioned illustration of a cut-out of a vehicle wheel having a bowl-like wheel disk which is connected to the wheel rim by means of connection arrangements, having two seals in a respective groove which extends radially around the periphery of the connection region of the wheel flange of the wheel disk in the contact face (connection face) of the wheel flange,

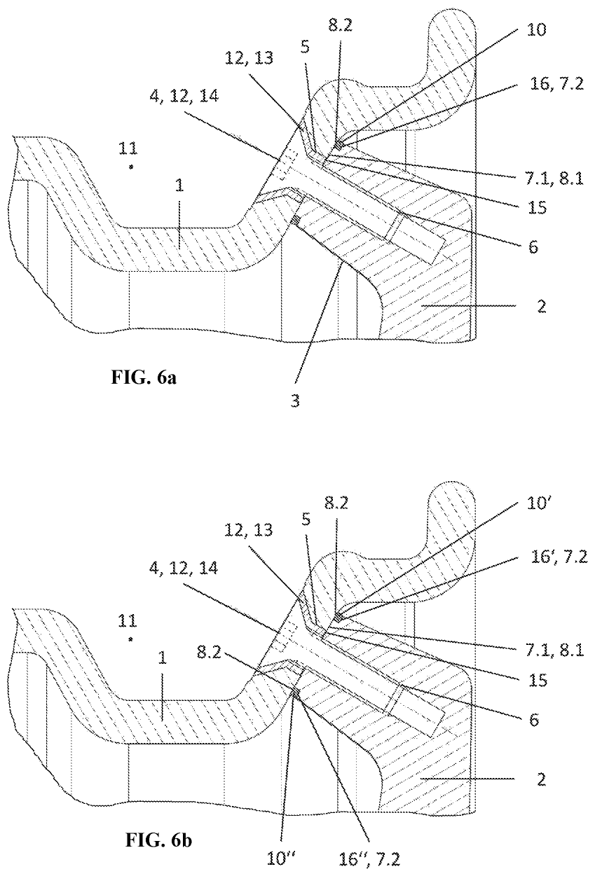

FIG. 6a is a sectioned illustration of a cut-out of a vehicle wheel having a star-like wheel disk which is connected to the wheel rim by means of connection arrangements, in each case having a seal in an annular recess in an edge zone of the connection region of the spoke of the wheel disk,

FIG. 6b is a sectioned illustration of a cut-out of a vehicle wheel having a bowl-like wheel disk which is connected to the wheel rim by means of connection arrangements, having two seals in a respective recess in an edge zone of the connection region of the wheel flange of the wheel disk,

FIG. 7 is a sectioned illustration of a cut-out of a vehicle wheel having a bowl-like wheel disk which is connected to the wheel rim by means of connection arrangements, having two seals in a groove which extends radially around the periphery of the connection region of the wheel rim in the contact face (connection face) of the connection region of the wheel rim,

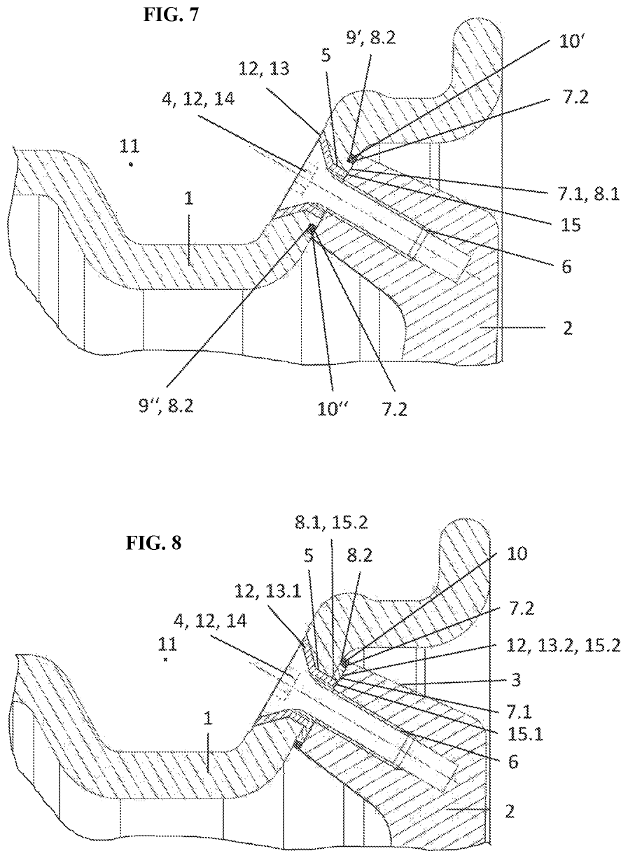

FIG. 8 is a sectioned illustration of a cut-out of a vehicle wheel with a star-like wheel disk which is connected to the wheel rim by means of alternative connection arrangements, in each case having an annular seal between the contact faces (connection faces) of the connection regions of the wheel rim and the spoke of the wheel disk,

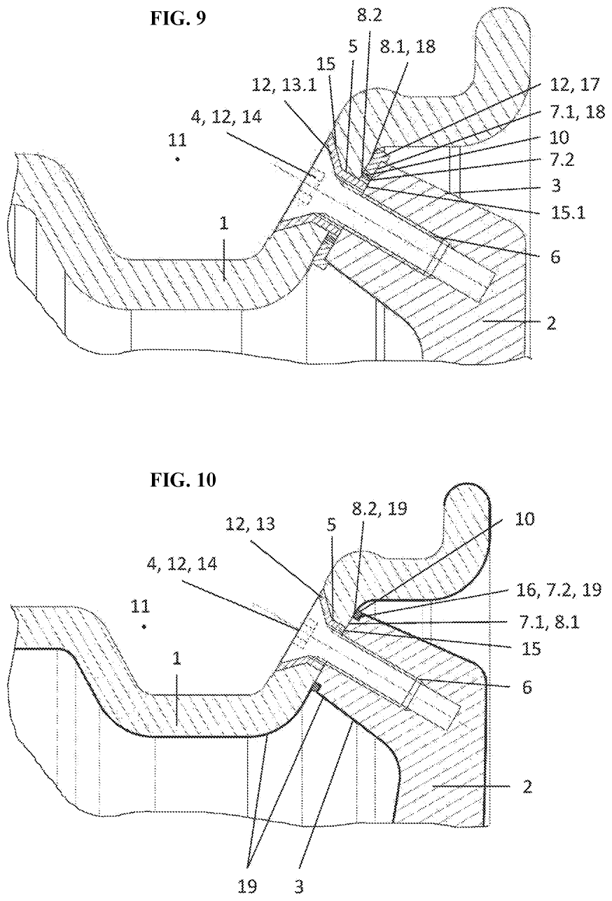

FIG. 9 is a sectioned illustration of a cut-out of a vehicle wheel having a star-like wheel disk which is connected to the wheel rim by means of additional alternative connection arrangements, in each case having an annular seal between the contact faces (connection face) of the connection regions of the wheel rim and the spoke of the wheel disk,

FIG. 10 is a sectioned illustration of a cut-out of a vehicle wheel having a star-like wheel disk which is connected to a coated wheel rim by means of connection arrangements, in each case having a seal in an annular recess in an edge zone of the connection region of the coated spoke of the wheel disk,

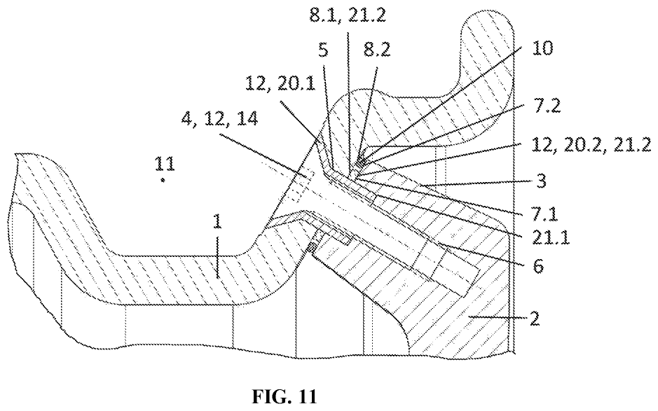

FIG. 11 is a sectioned illustration of a cut-out of a vehicle wheel having a star-like wheel disk which is connected to the wheel rim by means of alternative connection arrangements, in each case having an annular seal between the contact faces (connection faces) of the connection regions of the wheel rim and the spoke of the wheel disk.

In the examples explained below, reference is made to the appended drawings which form a part of the possible examples included by the invention and in which for the purposes of illustration specific embodiments in which the invention can be applied are shown.

Of course, other embodiments may also be used and structural or logical modifications can be made without departing from the protective scope of the present invention. The invention includes the fact that the features of the different exemplary embodiments described herein can be combined with each other, unless otherwise explicitly set out. The following extensive description is therefore not intended to be interpreted in a limiting sense; the protective scope of the present invention is defined by the appended claims.

In the context of this description, the terms “coupled”, “join” and “connected/connect” are used to describe both a direct and an indirect coupling, a direct or indirect joining and a direct or indirect connection.

In the Figures, identical or similar components/elements are given identical reference numerals as long as this is advantageous.

FIG. 1 shows a vehicle wheel having a wheel rim 1 and a star-like wheel disk 2 having wheel spokes 3. The wheel disk 2 and the wheel rim 1 comprises an aluminum alloy.

The wheel rim 1 is connected in a non-positive-locking manner to the star-like wheel disk 2 by means of a plurality of connection elements 4 which are arranged in accordance with the number of spokes around the periphery of the wheel rim and which are constructed, for example, as a screw. FIG. 1 is a section directly through a connection element 4, which engages through a passage 5 of the wheel rim 1 leading into a joining channel 6 of a wheel spoke 3 of the wheel disk 1, which joining channel is constructed with an inner thread 1.

In order to connect the star-like wheel disk 2 to the wheel rim 1, they each have special connection regions with connection faces at which these wheel elements adjoin each other. The connection region of the star-like wheel disk according to the embodiment is formed at the end of each spoke 3 of the wheel disk 2 and in each case has a connection face which is formed partially as the first contact face 7.1 and which in the illustrated assembled state of the vehicle wheel is directly in contact with a first contact face 8.1 of the connection face of the connection region of the wheel rim 1.

As a result of the non-positive-locking connection brought about by the connection elements 4 between the wheel rim 1 and the wheel disk 2, these first contact faces 7.1, 8.1 are subjected to a considerable surface pressure.

In another portion of the connection face of the connection region of the wheel disk 2 or the wheel spokes 3, adjacent to the first contact faces 7.1 of the spoke ends of the wheel spokes 3, concentrically arranged grooves 9 are formed in each case annularly around a joining channel 6.

A resilient seal 10 in the form of an O-ring (sealing ring) or a flat seal (annular sealing disk) which comprise fluoro rubber is arranged in each of the grooves 9.

The seals 10 consequently surround the connection elements 4 with a contact-free spacing and enclose the passage 5 through the wheel rim 1.

In the groove 9, second contact faces (sealing faces) 7.2 against which in the illustrated assembled state of the vehicle wheel the seal 10 lies directly are formed.

There is formed in another portion of the connection face of the connection region of the wheel rim 1 a second contact face (sealing face) 8.2 which in the illustrated assembled state of the vehicle wheel is directly in contact with the seal 10.

The resilient seal 10 has with respect to the dimensions of the groove 9 a specific excess dimension. Accordingly, the resilient seal 10 when the connection elements 4 are screwed is compressed to a defined thickness which corresponds to the groove depth. The pretensioning force of the screw 4 applies, via the connection face of the wheel rim 1 and consequently via the contact faces 8.1, 8.2 of the connection region of the wheel rim 1, and via the connection face of the wheel disk 2 and consequently via the contact faces 7.1, 7.2 of the connection region of the wheel rim 1, a pressing force to the seal 10 in the groove 9 which allows the seal 10 to be securely supported on the sealing faces 7.2 of the groove 9 and on the sealing face 8.2 which corresponds to the seal 10 in the connection face of the wheel rim 1 and thus ensures reliable sealing of the wheel rim 1 or the tire chamber 11 which is located on the rim outer side with respect to the external environment.

Under the compression stress of the resilient seal 10, the sealing effect is ensured even in the case of dynamically changing loading of the connection. As a result of the fixed arrangement of the sealing ring 10 in the groove 9, a creeping of the seal 10 and consequently the settling of the connection is further prevented.

The force transmission between the wheel rim 1 and the wheel disk 2 is not influenced by the seal 5 which acts partially on the sealing faces 7.2, 8.2 since the seal 10 is not located directly in the force path between the corresponding directly mutually contacting contact faces 7.1, 8.1 of the connection regions of the wheel disk 2 and the wheel rim 1, wherein the applied pressing force of the sealing ring 10 is negligibly small with respect to the pretensioning force of the screw 4 and consequently with respect to the surface pressure between the corresponding contact faces 7.1, 8.1.

FIG. 2 shows the star-like wheel disk 2 according to FIG. 1 in a clear isometric sectioned illustration. The star-like wheel disk 2 according to this embodiment comprises a total of eight spokes 3. At the spoke ends of the spokes 3, the connection faces are formed with the contact faces 7.1 and—as can be clearly seen—formed in each case with a groove 9 which is arranged so as to extend concentrically and annularly around the joining channel 6.

An O-ring (sealing ring) or a flat seal (annular sealing disk) of fluoro rubber is arranged in the grooves 9, as a seal 10 in each case.

FIG. 3 shows a vehicle wheel with a bowl-like wheel disk 2. The wheel disk 2 and the wheel rim 1 comprise an aluminum alloy.

The wheel rim 1 is connected in a non-positive-locking manner to the bowl-like wheel disk 2 by means of a plurality of connection elements 4 which are arranged in a state distributed around the periphery and which in the embodiment are constructed as a screw. FIG. 3 shows a section directly through a connection element 4 which engages through a passage 5 of the wheel rim 1 leading into a joining channel 6 of the wheel disk 2 constructed with an inner thread.

In order to connect the bowl-like wheel disk 2 to the wheel rim 1, they have in each case special connection regions with radially extending connection faces at which these wheel elements adjoin each other. In the bowl-like wheel disk 2, the connection region is formed on the outer periphery of the wheel disk 2 (wheel flange) and has a radially extending connection face which is partially formed as a radially extending first contact face 7.1 which in the illustrated assembled state of the vehicle wheel is directly in contact with the radially extending first contact face 8.1 of the connection face of the connection region of the wheel rim 1.

In another portion of the connection face of the connection region of the wheel disk 2, adjacent to the first contact faces 7.1 of the wheel disk 2, there are introduced along the periphery of the wheel disk 2 two grooves 9′, 9″ which extend with a specific spacing at both sides of the joining channels 6 of the wheel disk 2 which are arranged around the periphery of the wheel disk.

There are arranged in the grooves 9′, 9″ two resilient seals 10′, 10″ which are constructed as large O-rings (sealing rings) or flat seals (sealing strip) of fluoro rubber.

In the radially peripheral grooves 9′, 9″ there are formed second contact faces (sealing faces) 7.2 against which the seals 10′, 10″ lie directly in the illustrated assembled state of the vehicle wheel.

In another portion of the connection face of the connection region of the wheel rim 1, there are formed at both sides of the passages 5 of the connection elements 4 radially extending second contact faces (sealing face) 8.2, which in the illustrated assembled state of the vehicle wheel is in each case directly in contact with the seals 10′, 10″.

The operating principle of the force transmission of the connection from the connection element 4 via the first contact faces 7.1, 8.1 of the connection regions of the wheel flange of the wheel disk 2 and the wheel rim 1 and the sealing action via the sealing faces 7.2, 8.2 via the oversized seals 10′, 10″ in the grooves 9′, 9″ is carried out in a similar manner to the description according to FIGS. 1 and 2, to which reference may be made.

In the illustrated final state (assembled state), consequently, the two seals 10′, 10″ enclose at both sides all the passages 5 through the wheel rim 1 and surround all the connection elements 4 with contact-free spacing with respect to the connection elements 4.

All the connection elements 4 are located as a result of the external arrangement of the seals 10′, 10″ according to the invention together and completely in the excess pressure region of the tire chamber 11 so that the connection elements 4 do not have to be sealed individually.

FIG. 4 shows the bowl-like wheel disk 2 according to FIG. 3 for illustration as an isometric sectioned illustration.

The two grooves 9′, 9″ which extend radially over the periphery of the connection region of the wheel flange of the bowl-like wheel disk 2 and in which the seals 10′, 10″ extend in an annular manner can be seen clearly.

The grooves 9′, 9″ are arranged at both sides of the joining channels 6 so that the seals 10′, 10″ in the assembled state of the vehicle wheel not illustrated here completely surround all the connections which extend through the wheel rim 1 and the wheel disk 2.

This embodiment for sealing the wheel rim 1 is particularly efficient since it can be produced with little technical and technological complexity.

FIG. 5a shows a vehicle wheel with a wheel rim 1 and a star-like wheel disk 2 with spokes 3 which are connected in comparison with the embodiment according to FIGS. 1 and 2 by means of a plurality of connection arrangements 12 which are arranged in accordance with the number of spokes around the periphery of the wheel rim.

The wheel disk 2 comprises aluminum alloy whilst the wheel rim 1 according to this embodiment comprises fiber-composite material.

According to the embodiment according to FIGS. 1 and 2, in the connection faces, in particular in the contact faces 7 of the wheel spokes 3, first contact faces 7.1 and annular grooves 9 which are concentrically arranged in each case around a joining channel 6 with second contact faces 7.2 and in which a resilient sealing ring 10 or a sealing disk 10 of fluoro rubber is arranged are formed.

Only the differences with respect to the embodiment according to FIGS. 1 and 2 are intended to be explained below.

In the embodiment according to FIG. 5a, the non-positive-locking connection between the wheel rim 1 and the wheel disk 2 is carried out by means of the connection arrangements 12 which each comprise a screw 4 as a connection element 4 and an integral bush 13. The bush 13 covers the passage 5 of the wheel rim 1 and terminates flush with the connection face, in particular with the contact face 8.1 of the connection region of the wheel rim 1. The connection element 4 is guided through the bush 13 and engages in the inner thread of the joining channel 6 in the spoke ends of the wheel disk 2, wherein a screw head 14 of the screw 4 is located in the conically expanded edge of the bush 13.

The force path of the connection is carried out in this instance primarily via the connection element 4 and the bush 13 on the wheel rim 1 and the wheel disk 2, wherein an end-side contact face 15 of the bush 13 and the first contact face 8.1 of the connection region of the wheel rim 1 together with the first contact face 7.1 of the connection region of the wheel disk 2, wherein the contact faces are in each case directly in contact with each other as illustrated.

The bush 13, preferably of titanium alloy, serves to protect the fiber-composite material of the wheel rim 1 from undesirable vibration friction wear by compensating for the forces introduced by the screw 6 into the passage 5 of the wheel rim 1. In particular, the conically expanded edge of the bush 13 reduces the surface pressure in the edge region of the passage 5 through the wheel rim 1.

In the context of the invention, in this embodiment the annular groove 9 which is incorporated in the connection face, in particular in the contact face 7 of the wheel disk 2, is spaced apart from the joining channel 6 in such a manner that the enclosed seal 10 in the assembled state does not contact the bush 13 or the end-side contact face 15 of the bush 13.

Each of the seals 10 consequently surrounds in each case the entire connection arrangement 12 comprising the connection element 4 and bush 13 with a contact-free spacing.

The operating principle of the force transmission of the connection from the connection element 4 via the contact faces 7.1, 8.1, 15 of the connection regions of the spokes 3 of the wheel disk 2 and the wheel rim 1 and the sealing action via the sealing faces 7.2, 8.2 through the oversized seal 10 located in the annular groove 9 is carried out in a similar manner to the description according to FIGS. 1 and 2.

The entire connection arrangement 12 is located as a result of the external arrangement of the seal 10 according to the invention completely in the excess pressure region of the tire chamber 11 so that the components of the connection arrangement 12 which are involved in the connection do not have to be sealed separately.

FIG. 5b is an illustration for a similar embodiment according to FIG. 5a, but with a bowl-like wheel disk 2 using two radially peripheral seals 10′, 10″ according to the embodiment according to FIGS. 3 and 4.

Accordingly, in the radially peripheral connection face, in particular in the contact face 7 of the wheel flange of the bowl-like wheel disk 2, there are formed at both sides of the connection arrangements 12 a radially peripheral groove 9′, 9″ in which there is arranged a respective radially peripheral seal 10′, 10″, for example, comprising fluoro rubber, which enclose and seal all the connection arrangements 12 at both sides in a similar manner to the embodiment according to FIGS. 3 and 4.

FIG. 6a illustrates a variant of the embodiment according to FIG. 5a. A cut-out of a vehicle wheel with a star-like wheel disk 2 with spokes 3 of aluminum alloy and a wheel rim 1 of fiber-composite material is shown, in a state connected by means of a plurality of connection arrangements 12 and having an alternative arrangement of the seal 10.

Only the differences with respect to the embodiment according to FIG. 5a are intended to be explained below.

In the embodiment according to FIG. 6a, in place of an annular groove in the connection face, in particular in the contact face 7 of each spoke end of the star-like wheel disk 2, an edge-side, peripheral recess 16 is formed on the outer edge of the connection face, in particular in the contact face 7 of the spoke end and adjacent to the first contact face 7.1.

In this shoulder 16 which is formed in this manner around the first contact face 7.1, a seal 10 is arranged as a resilient sealing ring or annular sealing disk 10 which in a similar manner to the seal formation according to FIG. 5a in the connected state is compressed to a defined shape and thickness according to the annularly extending joint which is produced between the second contact faces (sealing faces) 8.2 of the connection region of the wheel rim 1 and the second contact faces (sealing faces) 7.2 of the recess 16 in the edge zone of the connection face of the connection region of the spokes 3 of the wheel disk 2.

Also in this manner, as described above, a reliable sealing action under the loading of the connection is ensured and at the same time the force transmission between the wheel rim and the wheel disk is not influenced in a disadvantageous manner.

Alternatively, the seal 10 according to FIG. 6a may also be constructed as a sealing mass, preferably, for example, of silicone. In this instance, the sealing can be carried out after the final assembly of the vehicle wheel in which the sealing mass 10 is pressed into the annularly extending joint which is produced between the connection face, in particular the contact face 7 of the wheel rim 1, and the recess 16 in the connection face of the wheel disk 2 and can subsequently harden.

As a result of the edge-side formation of a laterally open shoulder 16 of the spoke end, an unfavorably thin residual wall thickness of the spoke end which may, for example, be produced by an edge-side groove located close to the edge, is bypassed and consequently the risk of material breaking out from the spoke end, which could impair the reliability of the connection, is prevented.

In this regard, this embodiment is advantageous with connection arrangements 12 which require a particularly large amount of space or very narrow spokes which require a seal 10 which is supported particularly close to the edge of the spoke end in order to ensure the spacing with respect to the connection arrangement 12.

Furthermore, a milling of the recess or the shoulder 16 can be carried out in a very practical manner in technical production terms, and consequently in a particularly cost-effective manner.

FIG. 6b is an illustration of a similar embodiment according to FIG. 6a, but with a bowl-like wheel disk 2 using two seals 10′, 10″ which are arranged in an edge-side recess 16′, 16″ which extends radially around the connection region of the wheel flange of the wheel disk 2 according to FIGS. 3 and 4 and which seal all the connection arrangements 12 in a similar manner to the embodiment according to FIGS. 3 and 4 at both sides in an enclosed manner.

In this instance, in the edge zone of the radially peripheral connection face, in particular in the edge zone of the radially peripheral contact face 7 of the wheel flange of the bowl-like wheel disk 2 and adjacent to the radially peripheral first contact face 7.1, there is formed at both sides a shoulder 16′ 16″ with corresponding radially peripheral second contact faces 7.2 in which the seals 10′, 10″ are arranged.

Consequently, with respect to a groove formation with a narrow residual wall thickness in the peripheral connection face/contact face 7 of the wheel flange of the bowl-like wheel disk 2, the risk of material breaking away in the edge region of the peripheral connection face/contact face 7 of the wheel flange of the bowl-like wheel disk 2 can also be prevented in this case.

FIG. 7 shows a vehicle wheel having a bowl-like wheel disk 2 of aluminum alloy and a wheel rim 1 of fiber-composite material according to the embodiment according to FIGS. 5b and 6b, which in a similar manner to these embodiments are connected by means of a plurality of connection arrangements 12 which are arranged around the periphery of the wheel rim 1 and which each comprise a screw 4 and a single-piece bush 13.

Only the differences in relation to the embodiment according to FIGS. 5b, 6b are described below.

In the embodiment according to FIG. 7, in the connection region of the wheel rim 1 there are two radially extending grooves 9′, 9″ which are incorporated at both sides of the passages 5 of the wheel rim 1 and with spacing therefrom in the connection face, in particular in the contact face 8 of the connection region of the wheel rim 1.

The seals 10′, 10″ are arranged in these two grooves 9′, 9″.

In the context of the invention, also in this embodiment, the peripheral grooves 9′, 9″ which are incorporated in the connection face/contact face 8 are spaced apart from the passages 5 of the wheel rim 1 in such a manner that the enclosed seals 10′ 10″ do not contact the bushes 13 which in each case line a passage 5.

The seals 10′, 10″ also thereby enclose all the connection arrangements 12 of the wheel at both sides and with contact-free spacing.

The operating principle of the force transmission of the connection from the connection element 4 via the contact faces 7.1, 8.1, 15 of the connection regions of the spokes 3 of the wheel disk 2 and the wheel rim 1 and the sealing effect via the sealing faces 7.2, 8.2 via the oversized seals 10′, 10″ located in the peripheral grooves 9′, 9″ is carried out in a similar manner to the description according to FIGS. 5a, 5b and 6a, 6b and according to FIGS. 3 and 4.

It is conceivable and included by the invention that as an alternative to the above-described embodiment according to FIG. 7, in the connection region of the wheel rim 1, in a state spaced apart in each case around a passage 5 of the wheel rim 1, there is incorporated in the connection face/contact face 8 of the wheel rim 1 an annular groove 9 in which the seal 10 is arranged in each case.

Consequently, each connection arrangement 12 is individually enclosed and sealed by a seal 10 in each case.

It is further conceivable and included by the invention that the above embodiment according to FIG. 7 may also be constructed for a vehicle wheel with a star-like wheel disk 2 with spokes 3 and a wheel rim 1 in a similar manner to the embodiment according to FIGS. 5a and 6a, wherein in a state spaced apart around a passage 5 of the wheel rim 1 in each case there is incorporated into the individual connection faces/contact faces 8 of the wheel rim 1 which correspond to the connection faces of the spoke ends 3 of the wheel disk 2 an annular groove 9 in which a seal 10 is arranged in each case.

FIG. 8 shows a vehicle wheel having a star-like wheel disk 2 with spokes 3 of an aluminum alloy and a wheel rim 1 of fiber-composite material which in a similar manner to the embodiment according to FIGS. 5a and 6a are connected by means of a plurality of connection arrangements 12 which are arranged in accordance with the number of spokes around the periphery of the wheel rim 1.

Only the differences with respect to the embodiment of FIGS. 5a to 6a will be explained below.

The non-positive-locking connection between the wheel rim 1 and the wheel disk 2 is carried out in the embodiment according to FIG. 8 in contrast to the embodiments according to 5a and 6a by connection arrangements 12 which each comprise a screw 4 as a connection element 4 and a multi-portion bush 13 with two mutually engaging bush portions 13.1, 13.2. The bush portions 13.1, 13.2 may be formed from a different material, but both comprise in the embodiment titanium alloy.

The first bush portion 13.1 encloses the passage 5 of the wheel rim 1 and comprises a projection over the connection face, in particular over the contact faces 8.1, 8.2 of the connection region of the wheel rim 1. A second bush portion 13.2 in the form of a perforated disk surrounds the first bush portion 13.1 in an annular manner in the region of the projection and is consequently in the assembled state of the vehicle wheel supported between the first contact face 8.1 of the connection region of the wheel rim 1 and the first contact face 7.1 of the connection region of the spokes 3 of the wheel disk 2. The connection element 4 is guided through the first bush portion 13.1 and engages in the inner thread of the joining channel 6 in the wheel disk 2, wherein a screw head 14 of the connection element 4 is located in the conically expanded edge of the first bush portion 13.1.

The force path of the connection according to FIG. 8 is carried out primarily via the connection element 4 and the bush portions 13.1 13.2 on the wheel rim 1 and the wheel disk 2, wherein an end-side contact face 15.1 of the first bush portion 13.1 is directly in contact with the first contact face 7.1 of the connection region of the spokes 3 and the two-sided contact faces 15.2 of the second bush portion 13.2 are in each case directly in contact with the first contact face 8.1 of the connection region of the wheel rim 1 and with the first contact face 7.1 of the connection region of the spokes 3 of the wheel disk 2.

In this embodiment, the wheel disk 2 and the wheel rim 1 are indirectly in contact via the first contact face 7.1 of the connection region of the spokes 3 and the first contact face 8.1 of the connection region of the wheel rim 1, that is to say, via the first bush portion 13.1 and the second bush portion 13.2 of the connection arrangement 12.

As a result of the interposition of the second bush portion 13.2 between the first contact faces 7.1, 8.1, a joint is produced around the outer edge of the second, perforated-disk-like bush portion 13.2 between the free connection face/contact face 8 of the connection region of the wheel rim 1 and the free connection face/contact face 7 of the spoke ends of the wheel disk 2.

This joint which is produced can be used for the arrangement of the seal 10, for example, an oversized sealing ring or a sealing mass which in the assembled state lies against the sealing faces 7.2, 8.2 of the wheel disk 2 or the wheel rim 1, wherein according to the above embodiments a reliable sealing action under the load of the connection is ensured and the force transmission between the wheel rim 1 and wheel disk 2 remains uninfluenced.

The entire connection arrangement 12 is located as a result of the arrangement of the seal 10 according to the invention completely in the excess pressure region of the tire chamber 11 so that the components 4, 13.1, 13.2 of the connection arrangement involved in the connection do not have to be separately sealed.

According to the invention, the seal 10 is constructed and arranged in such a manner that it has a radial spacing with respect to the periphery of the perforated-disk-like, second bush portion 13.2 so that the seal 10 additionally remains uninfluenced by the micro-movements of the connection arrangement 12 to the greatest possible extent.

This embodiment of the connection arrangement 12 according to FIG. 8 improves, on the one hand, the compensation for the micro-movements which occur in the connection. As a result of the multi-portion bush with the bush portions 13.1, 13.2, the vibration friction wear of the fiber-composite material of the wheel rim 1 resulting from the micro-movements between the wheel disk 2 and wheel rim 1 can be further reduced without reducing the sealing action. Consequently, the reliability of the connection of a wheel disk 2 to a wheel rim 1 in particular of fiber-composite material is further increased.

On the other hand, the geometry of the two-portion bush 13.1, 13.2 which protrudes at the rim inner side minimizes the necessary precautions for the placement and fixing of the seal 10 between the connection faces/contact faces 7, 8 of the wheel rim 1 and the wheel disk 2. In particular, no grooves, shoulders or recesses for fixing the position of the seal 10 in the connection faces/contact faces 7, 8 have to be provided, which, on the one hand, simplifies and makes the production of the sealing connection of the vehicle wheel more cost-effective and, on the other hand, prevents local weakening of the wheel rim 1, in particular comprising fiber-composite material, and the wheel disk 2.

FIG. 9 shows a vehicle wheel having a star-like wheel disk 2 with spokes 3 of aluminum alloy and a wheel rim 1 of fiber-composite material similar to the embodiment according to FIG. 8.

In the embodiment according to FIG. 9, the non-positive-locking connection between the wheel rim 1 and the wheel disk 2 is carried out by means of a plurality of connection arrangements 12 which are arranged around the periphery of the vehicle wheel in accordance with the number of spokes and which comprise a screw 4 as a connection element 4 and a bush 13.1 which encloses the passage 5 and which protrudes beyond the connection face and in particular beyond the contact faces 8.1, 8.2 of the wheel rim 1, in a similar manner to the first bush portion 13.1 in the embodiment according to FIG. 8, and furthermore a perforated disk 17 which is arranged separately from the bush portion 13.1.

The bush 13.1 and perforated disk 17 comprise, for example, a titanium alloy.

The perforated disk 17 is supported in the assembled state of the vehicle wheel between the connection face/contact face 8 of the connection region of the wheel rim 1 and the connection face/contact face 7 of the connection region of the spokes 3 of the wheel disk 2, wherein the perforated disk 17 extensively surrounds the passage 5 of the wheel rim 1. The perforated disk 17 has an angled edge which encloses the edge region of the connection face of the spoke end 3 of the wheel disk 2 and at the same time fixes the perforated disk 17 in position.

The connection element 4 is guided through the bush portion 13.1 and engages in the inner thread of the joining channel 6 in the wheel disk 2, wherein a screw head 14 is located in the conically expanded edge of the bush portion 13.1.

The force path of the connection is carried out here primarily via the connection element 4, the bush portion 13.1 and the perforated disk 17 on the wheel rim 1 and the wheel disk 2, wherein the end-side contact face 15.1 of the bush portion 13.1 is directly in contact with the first contact face 7.1 of the connection region of the spokes 3 and the two-sided contact faces 18 of the perforated disk 17 are in direct contact in each case with the first contact face 7.1 of the spokes 3 of the wheel disk 2 and with the first contact face 8.1 of the wheel rim 1.

In this embodiment, the wheel disk 2 and the wheel rim 1, via the first contact face 7.1 of the connection region of the spokes 3 and the first contact face 8.1 of the connection region of the wheel rim 1 are also indirectly in contact, that is to say, via the bush portion 13.1 and the perforated disk 17 of the connection arrangement 12.

The perforated disk 17 is constructed and arranged in such a manner that, in the assembled state at the inner side (hole side), an annular hollow space is formed and is delimited by a free portion of the connection face/contact face 8 of the connection region of the wheel rim 1, a free portion of the connection face/contact face 7 of the connection region of the spokes 3 of the wheel disk 2 and a peripheral face of the bush portion 13.1.

This hollow space can be used for the arrangement of the seal 10, in particular as a sealing ring or annular sealing disk.

The seal 10 is in the assembled state incorporated in the hollow space with play/with spacing between the outer wall/outer peripheral face of the bush 13.1 and the inner wall of the perforated disk 17 and seals in accordance with the reliable sealing manner according to the above embodiments the tire chamber 11 of the wheel rim 1 with a contact-free and damage-free spacing from the connection arrangement 12.

In the arrangement according to FIG. 9, not the entire connection arrangement 12, but in addition to the connection element 4 only the bush portion 13.1 of the connection arrangement 12 is located in the excess pressure region of the tire chamber 11, wherein the seal 10 is arranged in a manner enclosed by another component of the connection arrangement (perforated disk 17).

Consequently, on the one hand, secure sealing of the tire chamber 11 of the wheel rim 1 is ensured and, on the other hand, an additional protection of the seal 10 is provided from external harmful influences of the environment.

According to the invention, the embedded seal 10 is constructed and arranged in such a manner that, on the one hand, it surrounds the outer wall/outer peripheral face of the bush 13.1 with spacing and, on the other hand, is arranged with spacing from the inner wall of the perforated disk 17.

Consequently, the incorporated seal 10 is located with contact-free, damage-free spacing from the connection arrangement 12 and is in the incorporated arrangement thereof additionally protected from external harmful influences of the environment.

In the above embodiment according to FIG. 9, grooves, shoulders or recesses for fixing the position of the seal 10 in the connection faces/contact faces 7, 8 of the wheel rim 1 or the wheel disk 2 are also dispensable, which, on the one hand, makes the production of the sealing connection of the vehicle wheel simpler and more cost-effective and, on the other hand, prevents local weakening of the wheel rim 1 and the wheel disk 2.

Not least the perforated disk 17 of the connection arrangement 12 which can be seen externally (from the outer side) can be used to configure the vehicle wheel.

The embodiment according to FIG. 9 can also be conceived as an embodiment having a bowl-like wheel disk 2 using one or more perforated plates (perforated metal strips) which extend around the periphery of the wheel flange of the wheel disk 2 and which enclose the wheel flange (not illustrated).

A perforated plate which is constructed as a whole/in one piece (not illustrated) may be constructed so as to extend radially in a strip-like manner with corresponding perforated recesses around the periphery of the wheel flange in order in the assembled state to surround the passages of the connection elements 4 or the connection arrangements 12 and the seals (sealing rings) 10 thereof in each case with spacing.

A plurality of perforated plates may, for example, be arranged in a state divided in two at both sides of the wheel flange of the wheel disk 2 and may be constructed to extend radially in a strip-like manner with a consistent or different strip width or with corresponding recesses around the periphery of the wheel flange in order thus in the assembled state to surround the passages of the connection elements 4 or the connection arrangements 12 and the seals (sealing rings or radially peripheral seal) 10 thereof in each case with spacing. The two divided perforated plates may thus be constructed in such a manner that they lie against each other at the intermediate spaces adjoining the seals (sealing rings) 10.

These embodiments may also enclose the sealing rings 10 completely and with play which in turn enclose all the connection elements 4 or connection arrangements 12 with play and in a completely sealing manner.

Such embodiments and arrangements of the perforated plate or perforated plates also protect the sealing rings 10 from external harmful influences of the environment.

FIG. 10 shows a vehicle wheel with a star-like wheel disk 2 with spokes 3 of aluminum alloy, for example, EN AW-6082, and a wheel rim 1 of fiber-composite material, for example, CFRP with epoxy resin matrix which in a similar manner to the embodiment according to FIG. 6a are connected by means of a plurality of connection arrangements 12 which are arranged in accordance with the number of spokes around the periphery of the wheel rim 1.

Only the differences in relation to the embodiment according to FIG. 6a will be explained below.

The seal 10 is arranged in the annularly extending joint between the second contact faces (sealing faces) 8.2 of the connection region of the wheel rim 1 and the second contact faces (sealing faces) 7.2 of the recess 16 in the edge zone of the connection face of the connection region of the spokes 3 of the wheel disk 2.

The surface of the wheel rim 1 at the inner side and the surface of the spokes 3 of the wheel disk 2 are in each case covered with a coating 19/layer of paint 19, for example, based on a two-component acrylic paint system which primarily serves to mechanically protect and seal the wheel rim 1 of fiber-composite material and the wheel disk 2 of aluminum. The coating 19 may be constructed in multiple layers from individual paint layers 19.

This coating 19/layer of paint 19 additionally covers the second contact face (sealing face) 8.2 of the connection region of the wheel rim 1 and the second contact faces (sealing faces) 7.2 of the recess 16 completely so that the coating/layer of paint 19 is arranged between the seal 10 and the respective second contact faces 7.2 and 8.2.

With this coating 19/layer of paint 19, moisture is prevented from penetrating from the outer side and via the boundary regions between the seal 10 and the sealing face(s) 7.2, 8.2 into the connection between the wheel rim 1 and wheel disk 2 and into the connection arrangement 12, whereby occurrences of corrosion as a result of the material combinations used between the wheel rim 1, wheel disk 2 and connection arrangement 12 can be prevented.

Explicitly, the first force-transmitting contact faces 7.1, 8.1 in the connection region of the wheel disk 2 and the wheel rim 1 comprise no coating 19 so that coating material is prevented from being located in the force path of the connection in order not to impair the effectiveness of the force transmission for ensuring the high connection quality.

This embodiment of the coating 19 may also be used in all embodiments described above.

FIG. 11 shows a vehicle wheel having a star-like wheel disk 2 with spokes 3 of aluminum alloy and a wheel rim 1 of fiber-composite material, which, in a similar manner to the embodiment according to FIG. 8, are connected to each other by means of a plurality of connection arrangements 12 which are arranged in accordance with the number of spokes around the periphery of the wheel rim 1.

Only the differences in relation to the embodiment according to FIG. 8 will be explained below.

The connection arrangements 12 for non-positive-locking connection between the wheel rim 1 and the wheel disk 2 each have a screw 4 as a connection element 4 and a multi-portion longitudinal bush 20 having two mutually engaging bush portions 20.1, 13.2. The multi-portion longitudinal bush 20 comprises a first longitudinal bush portion 20.1, which encloses the passage 5 of the wheel rim 1 and which coaxially surrounds the connection element 4, and a second perforated-disk-like longitudinal bush portion 20.2, which surrounds the first longitudinal bush portion 20.1 in an annular manner.

The connection element 4 is guided through the first longitudinal bush portion 20.1 and engages in the inner thread of the joining channel 6 in the wheel disk 2, wherein the screw head 14 is located in the conically expanded edge of the longitudinal bush portion 20.1.

The second perforated-disk-like longitudinal bush portion 20.2 is supported in the assembled state of the vehicle wheel between the first contact face 8.1 of the connection region of the wheel rim 1 and the first contact face 7.1 of the connection region of the spoke ends 3 of the wheel disk 2.

The shaft of the first longitudinal bush portion 20.1 comprises in the assembled state of the vehicle wheel a clear projection over the contact faces 8.1, 8.2 of the connection region of the wheel rim 1 and over the second, perforated-disk-like longitudinal bush portion 20.2, wherein the shaft of the first longitudinal bush portion 20.1 extends into a recess of the joining channel 6 of the spoke 3 of the wheel disk 2, which recess corresponds to the shape of the shaft, so that the longitudinal bush portion 20.1 is connected in a positive-locking manner to the wheel disk 2.

The seal 10, for example, an oversized sealing ring or a sealing mass can be arranged in the joint which is formed between the connection region of the wheel rim 1 and the spoke ends 3 by the interposition of the second longitudinal bush portion 20.2 between the contact faces 7.1, 8.1, wherein this is constructed and arranged in such a manner that it maintains a radial spacing with respect to the periphery of the second longitudinal bush portion 20.2. In this manner, the seal remains uninfluenced by the force transmission and dynamic micro-movements between the wheel rim 1 and wheel disk 2 to the greatest possible extent and consequently ensures a reliable sealing action.

With this embodiment of the connection arrangement 12 by means of the multi-portion longitudinal bush 20, there is a particularly efficient differentiation of the force transmission via the connection by the screw 4 as a connection element selectively taking over the transmission of the longitudinal or tensile forces in an axial direction and the coaxially surrounding longitudinal bush portion 20.1 receiving transverse forces and bending torques in a radial direction.

In contrast to FIG. 8, where the transverse forces and bending torques are transmitted in a radial direction via the frictional engagement resulting from the screw pretensioning, as a result of the positive-locking embedding of the first longitudinal bush portion 20.1 in the spoke 3, a substantially more rigid and play-free connection is produced between the wheel rim 1 and wheel disk 2. The dynamic micro-movements between the wheel rim 1 and the wheel disk 2 can thereby be further reduced, whereby the influence of these micro-movements on the seal 10 further decreases and consequently the sealing action can be further improved.

Naturally, the invention also includes embodiments of connection arrangements 12 which comprise a single-piece longitudinal bush 20 which, for example, comprises only the first longitudinal bush portion 20.1. These embodiments could be used with the same above-described advantageous effects, for example, as an alternative to the bush 13 in the embodiments according to FIGS. 5a, 5b, 6a, 6b and 7.

The term “and/or” used in the claims, when it is used in a series of two or more elements, means that each of the listed elements can be used alone or any combination of two or more of the listed elements can be used.

If, for example, a relationship which contains the components A, B and/or C is described, the possible relationship may contain the component A alone; B alone; C alone; A and B in combination; A and C in combination; B and C in combination; or A, B and C in combination.

### LIST OF REFERENCE NUMERALS

1 Wheel rim
2 Wheel disk
3 Spoke
4 Connection element, screw
5 Passage of the wheel rim
6 Joining channel of the wheel disk
7 Contact face (of the connection region of the wheel disk)
7.1 First contact face
7.2 Second contact face (sealing face)
8 Contact face (of the connection region of the wheel rim)
8.1 First contact face
8.2 Second contact face (sealing face)
9 Groove ′, ″
10 Seal, sealing ring, sealing disk, sealing mass ′, ″
11 Tire chamber
12 Connection arrangement
13 Bush, bush portion
13.1 First bush portion,
13.2 Second bush portion
14 Screw head
15 Contact face (of the bush, the bush portion)
15.1 Contact face of the first bush portion
15.2 Contact face of the second bush portion
16 Recess, shoulder ′, ″
17 Perforated disk
18 Contact face (of the perforated disk)
19 Coating/layer of paint
20 Longitudinal bush
20.1 First longitudinal bush portion
20.2 Second longitudinal bush portion
21 Contact face (of the longitudinal bush, the longitudinal bush portion)
21.1 Contact face of the first longitudinal bush portion
21.2 Contact face of the second longitudinal bush portion

1.-17. (canceled)

18. A vehicle wheel comprising:
a wheel disk;
a wheel rim;
a connection element that connects the wheel disk to the wheel rim;
wherein the connection element is guided through a passage in the wheel rim and is joined in the wheel disk; and
a seal configured to hermetically seal the passage of the wheel rim and arranged between a wheel disk connection region and a wheel rim connection region, wherein the seal surrounds the connection element in a contact-free manner.

19. The vehicle wheel of claim 18 wherein the seal is arranged between at least one wheel disk connection face of the wheel disk connection region and at least one wheel rim connection face of the wheel rim connection region.

20. The vehicle wheel of claim 18 wherein the connection element is part of a multi-part connection arrangement, wherein the seal is arranged in a contact-free manner with respect to the connection arrangement.

21. The vehicle wheel of claim 19 wherein the seal is constructed and arranged such that at least one wheel disk connection face or a portion of the wheel disk connection face of the wheel disk and at least one wheel rim connection face or a portion of the wheel rim connection face of the wheel rim is formed in each case as a first contact face for direct contact of the wheel disk with the wheel rim and/or for indirect contact of the wheel disk and/or the wheel rim by means of a connection arrangement.

22. The vehicle wheel of claim 19 wherein at least one wheel disk connection face or a portion of the wheel disk connection face of the wheel disk and at least one wheel rim connection face or a portion of the wheel rim connection face of the wheel rim is formed in each case as a second contact face for direct contact of the seal with the wheel disk and with the wheel rim.

23. The vehicle wheel of claim 20 wherein the connection arrangement comprises one or more bush portions.

24. The vehicle wheel of claim 20 wherein the connection arrangement comprises one or more perforated disks and/or one or more perforated plates.

25. The vehicle wheel of claim 20 wherein the seal is arranged so as to extend coaxially around one or more connection elements or around one or more connection arrangements.

26. The vehicle wheel of claim 18 wherein at least two seals are arranged so as to extend radially around the periphery of the wheel disk or the wheel rim.

27. The vehicle wheel of claim 22 wherein the seal is connected in a substance-to-substance manner to the second contact face of the wheel disk connection region of the wheel disk and/or to the second contact face of the wheel rim connection region of the wheel rim.

28. The vehicle wheel of claim 19 wherein in a wheel disk connection face and/or in a wheel rim connection face there is formed one or more grooves in which the seal is arranged.

29. The vehicle wheel of claim 19 wherein in an edge zone of a wheel disk connection face and/or in an edge zone of wheel rim a connection face there is formed a recess in which the seals is arranged.

30. The vehicle wheel of claim 18 wherein the seal is constructed as a sealing element.

31. The vehicle wheel of claim 18 wherein the seal is formed from a sealing mass.

32. The vehicle wheel of claim 18 wherein the seal comprises resilient material.

33. The vehicle wheel of claim 22 wherein the second contact face of the wheel disk connection region of the wheel disk and/or the second contact face of the wheel rim connection region of the wheel rim comprises a fluid-tight coating.

34. The vehicle wheel of claim 20 wherein the connection arrangement comprises one or more longitudinal bush portions.
